(19) United States
(12) Patent Application Publication
(10) Pub. No.: US 2022/0040741 A1
(43) Pub. Date: Feb. 10, 2022

(54) SYSTEMS AND METHODS FOR SURFACE CLEANING AND COATING

(71) Applicant: Global Barrier Services, Inc., San Clemente, CA (US)

(72) Inventor: Gordon W. Davies, Carlsbad, CA (US)

(21) Appl. No.: 17/392,982

(22) Filed: Aug. 3, 2021

Related U.S. Application Data
(60) Provisional application No. 63/061,891, filed on Aug. 6, 2020.

(51) Int. Cl. B08B 9/093; B08B 3/02

(52) U.S. Cl. CPC B08B 9/093; B08B 3/02

(57) ABSTRACT

Systems and methods are provided in which residual materials are removed from an interior surface of a drum or similar vessel at the end of a duty cycle. This is followed by application of a non-siliceous aqueous solution to the cleaned surface, which provides a durable low-friction coating to the interior wall of the rotating drum mixer throughout the following duty cycle or use.

This application claims priority to U.S. Provisional Patent Application No. 63/061,891 filed on Aug. 6, 2020. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is cleaning and coating of working and storage surfaces, particularly those involved in mixing cementitious materials.

### BACKGROUND

The following description includes information that may be useful in understanding the present invention. It is not an admission that any of the information provided herein is prior art or relevant to the presently claimed invention, or that any publication specifically or implicitly referenced is prior art.

Rotating drum mixers are frequently used to mix components used in the production of concrete. On mixing, however, such materials first form a thick, plastic mass that tends to adhere to the interior working surfaces of the rotating drum mixer. While dispensing the concrete mixture removes most of this material from the rotating drum mixer a significant amount inevitably remains adhered to the interior wall. Attempts are made to remove as much of this material as possible in order to ready the rotating drum mixer for the next job, generally by adding water to the rotating drum mixer, mixing, dispensing the wash water, and repeating until the wash water is suitably clear. Such a process fails to remove all of the residual concrete mixture, which in turn necessitates labor-intensive and potentially dangerous manual removal of hardened material from the interior of the rotating drum mixer.

Similar issues arise with other working and storage vessels. For example, storage tanks (such as those of tanker trucks and railroad cars) can retain residual materials after emptying, which must be removed prior to refilling. This is particularly true when the stored materials are viscous or subject to degradation or decomposition, and/or when a variety of different materials are stored. Similarly, vessels used to control and contain chemical or biological reactions (such as catalytic reactors, fermenters, etc.) require careful and thorough cleaning between uses.

One approach to resolving this problem is to include devices or features within a vessel of drum mixer that act to dislodge residual materials. For example, U.S. Patent Application Publication No. 2004/0065357 (to Burch) describes a rotating drum mixer that incorporates an expandable membrane that is positioned to dislodge residual concrete from a rotating drum mixer. Such a device, however, reduces the operating capacity of such a rotating drum mixer, and adds significantly to the device's complexity. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

U.S. Pat. No. 10,100,206 (to Wetherell) describes the use of a high pressure spray of a suspension of silica particles in order to dislodge residual cementitious materials from the interior of a rotating drum mixer, and also describes application of such suspensions to reduce adhesion of cementitious material to the interior walls. Use of such methods and compositions is problematic, however, as the use of high pressure spray and the inevitable environmental contamination with silica particles is potentially hazardous.

In a related approach European Patent No. 2548924 (to Micheletti) describes application of an organic solution of siloxane polymer to the interior of a rotating drum mixer in order to provide a surface with reduced adhesion. The process, however, requires that the interior surface of the rotating drum mixer be both clean and dry prior to application of the organic solution. Unfortunately, it is not clear how environmental factors (such as rain and/or humidity) may impact attempts at applying such a coating, and such a method necessarily introduces organic solvent vapor to the environment.

U.S. Pat. No. 3,895,756, to Jaeger, describes a complex spray assembly in which multiple outlets oriented perpendicular to one another are rotated as they dispense high pressure streams of cleaning liquid. U.S. Pat. No. 4,941,491, to Goerss and Farrah, describes a similar approach in which a device carrying a pair of fluid dispensing outlets on a rotating arm is inserted into a tank and then pivoted as a cleaning liquid is dispensed. Similarly, U.S. Pat. No. 5,718,382, to Jaeger, describes a device for cleaning tanks in which nozzles that dispense cleaning fluid are provided with a series of fluid-tight joints, allowing them to be oriented in a variety of directions during a cleaning process. All of these involve the application of high pressure in order to direct cleaning liquids to interior surfaces that are distant from the dispensing outlet. Reliance on fluid-tight joints, however, limits the pressures that can be applied and necessarily limits the size of vessels to which such devices can be applied effectively.

Thus, there is still a need for a safe, convenient, and effective method for removing and/or preventing buildup of contaminating or residual materials on working surfaces.

### SUMMARY OF THE INVENTION

The inventive subject matter provides apparatus, systems and methods that facilitate cleaning and surface treatment of the interior of drums (such as a rotating drum mixer) and similar vessels. A spray system is provided that directs a spray or jet of cleaning fluid against an interior wall of the drum or similar vessel, followed by application of a spray or mist of a non-siliceous coating fluid that generates a durable low-friction coating on the interior wall. This low friction coating persists throughout the next duty cycle or use and facilitates subsequent removal of materials adhering to the interior wall.

One embodiment of the inventive concept is a system for cleaning cementitious materials from a work surface (such as an interior surface of a rotating drum mixer) that includes an elongated support, a first spray assembly (which includes a first outlet configured to produce a stream of dispensed cleaning liquid) coupled to a terminus of the elongated support, and a mist assembly (which includes a second outlet configured to atomize a coating liquid) attached to the terminus. The first spray assembly is in fluid communication with a first aqueous wash fluid (such as pond water) and the mist assembly is in fluid communication with an aqueous surface treatment solution. The first aqueous wash fluid is pressurized to from about 50 psi (344.7 kPa) to about 150 psi (1034.2 kPa). The aqueous surface treatment solution generates a persistent low friction coating on contact with the working surface. In some embodiments the first spray assembly is in fluid communication with a second aqueous wash fluid (such as fresh water, and includes a valve that is in fluid communication with the first and second aqueous wash fluids and the first spray outlet. In other embodiments the system includes a second spray assembly that is in fluid communication with a second aqueous wash fluid.

Such systems can include an articulated assembly that supports the elongated support, and that is configured to extend vertically. In some embodiments the system can include an extendable support that is attached to the elongated support, such that extension of the extendable support displaces the first spray assembly horizontally. Systems of the inventive concept can include a controller configured to: (i) dispense a stream of pond water onto the working surface, (ii) following dispensing of the stream of pond water, dispensing a stream of fresh water onto the working surface, and (iii) following dispensing of the stream of fresh water, dispensing a mist of the aqueous surface treatment solution onto the working surface through the mist assembly.

Another embodiment of the inventive concept is a method of cleaning and coating a working surface (for example, from residual cementitious materials) by using a system as described above to dispense a first water spray through a first spray assembly onto a contaminated working surface to generate a first waste water and a partially cleaned working surface, then subsequently removing the first waste water from the partially cleaned working surface, dispense a second water spray through a second spray assembly onto the partially cleaned working surface to produce a second waste water and a cleaned work surface, remove the second waste water from the cleaned work surface, and dispense a non-siliceous aqueous coating solution onto the cleaned work surface using a misting assembly. The first spray assembly and the second spray assembly can be the same spray assembly. In some embodiments the first spray assembly and the contaminated working surface move relative to each other as the first water spray is dispensed. In some embodiments the second spray assembly and the partially cleaned working surface move relative to each other as the second water spray is dispensed. In some embodiments the misting assembly and the cleaned working surface move relative to each other as the non-siliceous coating solution is dispensed. The first spray assembly, second spray assembly, and misting assembly can be displaced vertically and/or horizontally using an elongated support and an articulated frame to bring them into proximity of the working surface prior to dispensing. Data from a sensor can be used to position the first spray assembly, second spray assembly, and/or misting assembly using a controller.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts an example of a spray assembly of the inventive concept.

FIG. 2 depicts an example of a system of the inventive concept with a wheeled, articulated frame lifting and tilting an elongated support into position for insertion of spray and misting nozzles into a rotating drum mixer.

FIG. 3 depicts horizontal displacement of the elongated support of the exemplary system shown in FIG. 2 to move the spray and misting assemblies into the interior of a rotating drum mixer.

FIG. 4 depicts insertion of the spray and misting assemblies of the exemplary system shown in FIG. 3 into the interior of the rotating drum mixer and dispensing of a cleaning water spray onto the interior surface/wall.

FIG. 5 shows repositioning of the spray and misting nozzles during dispensing of cleaning water onto the rotating drum mixer interior wall for the exemplary system shown in FIG. 4.

FIG. 6 depicts dispensing of a mist of a non-siliceous aqueous coating solution onto the cleaned interior wall of the rotating drum mixer by the exemplary system shown in FIG. 5.

FIG. 7 depicts repositioning of the spray and misting nozzles during dispensing of the mist of a non-siliceous aqueous coating solution onto the cleaned interior wall of the rotating drum mixer by the exemplary system shown in FIG. 6.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems and methods in which residual materials are removed from a working surface (such as the interior of a rotating drum mixer used in the production of concrete, a tank or vessel used for liquid storage, etc.)) at the end of a duty cycle, followed by application of a non-siliceous aqueous solution to the cleaned surface. The non-siliceous aqueous solution provides a durable and/or persistent low-friction coating that prevents and/or reduces adhesion of materials to the interior wall of a treated drum, tank, or vessel throughout the following duty cycle (e.g. a working day)—at the end of which the process can be repeated. Such a system can include a boom or similar support (which can be extendable) that can include one or more fluid dispensing nozzles, which can be configured to deliver a pressurized stream of fluid that is directed toward the interior walls of the drum, tank, or vessel. and/or to deliver a mist of atomized fluid that coats the interior walls of the drum, tank, or vessel upon delivery. In some embodiments the boom can include two or more fluid delivery nozzles, which can have different configurations. In other embodiments the boom can include a single fluid delivery nozzle.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

It should be appreciated that while many embodiments provided below are described in terms of a rotating drum mixer used for mixing concrete or other cementitious materials, such embodiments are also applicable to other vessels and containers, including stationary storage tanks, mobile storage tanks, tanker trucks, tanker railroad cars, chemical reactors, composters, fermenters, etc. Such tanks and vessels can be rotatable, or can be held in a single position while in use.

Systems used for cleaning and coating such work surfaces can include an elongated support or boom that is sufficiently long to extend into the interior of a rotating drum mixer, a storage tank, and/or a storage vessel and/or along its length. One or more spray assemblies is/are positioned at the end of the elongated support. Such a spray assembly can be used to direct a stream of water onto the work surface (e.g. an interior wall of a rotating drum mixer, storage tank, or vessel) in order to dislodge adhered cementitious and/or other residual materials. In a preferred embodiment such a work surface has been initially and then subsequently treated with a non-siliceous aqueous solution that provides a low or reduced friction coating, which in turn facilitates removal of cementitious materials and/or other residual materials. Such an elongated support can also include one or more sensors (e.g. acoustic sensors, cameras, proximity sensors, etc.) that facilitate proper positioning relative to the working surface.

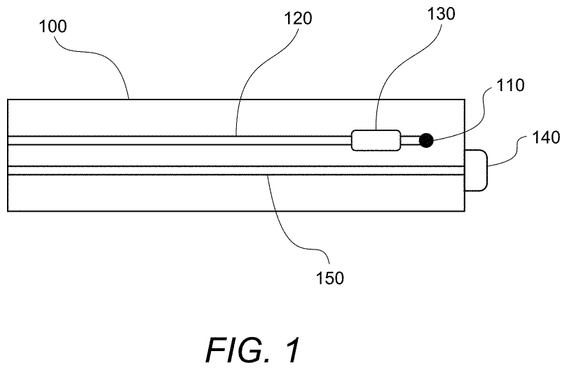

In some embodiments, as shown in FIG. 1, at least one spray assembly is provided that that is mounted on a boom or elongated support (100) and includes one or more spray or stream nozzle(s) (110) configured to dispense a defined stream of pressurized cleaning fluid, and that are in fluid communication with one or more sources of cleaning fluid (e.g. water). Such sources can be pressurized, for example, by utilizing a reservoir containing compressed air and/or incorporation of one or more pumps within the fluid path. If multiple sources of cleaning fluid are used a valve can be provided that permits switching between such fluid sources. For example, a source of pond water can be used for initial removal of cementitious material, followed by clean water. In other embodiments two or more spray assemblies can be provided at the end of the elongated support, each connected to a different cleaning water source. In such an embodiment different spray assemblies can be implemented at different steps of the cleaning process in order to provide an optimally cleaned work surface. In some embodiments, one or more spray or stream nozzles of a spray assembly can include an actuator for orienting the spray or stream nozzle relative to the spray assembly, permitting adjustment of the direction of a spray or stream of cleaning fluid (liquid or gas) prior to or during a cleaning process.

As noted above, such spray assemblies can include one or more spray or stream nozzles (110) that are shaped to provide a defined stream of fluid (e.g. water, pressurized air) having sufficient force to dislodge materials retained on a working surface. For examples, such a spray nozzle (110) can have a circular or approximately circular aperture at or near its terminus that directs and pressurizes a stream of cleaning fluid (e.g. water, air, an air/water mixture, etc.).

In some embodiments of the inventive concept such a stream nozzle (110) or a portion of the fluid path feeding the stream nozzle (120) can include a laminar flow device (130). Suitable laminar flow devices are configured to reduce turbulence within the cleaning fluid stream, thereby reducing dispersal and/or increasing velocity of the dispensed cleaning fluid. Suitable laminar flow devices include an assembly of parallel tubes, channels, or grooves within the flow path of the cleaning fluid (e.g. within or proximal to the stream nozzle) that are in contact with the cleaning fluid as it is being dispensed.

In a preferred embodiment a spray assembly can include at least four nozzles, with one or more directed to one or more ends or edges of the work surface and at least one directed to a central portion. Such nozzles can be distributed along a center line of a boom inserted into the vessel being cleaned or distributed laterally (e.g. on a left and/or right side of such a boom). In some embodiments a subset of such nozzles can be positioned at about a 0° to 90° angle (e.g. about 30° to 60°, about 45° to 50°, etc.) and a second subset of such nozzles can be positioned at about 180° to 270° (e.g. about 210° to 260°, about 240° to 250°, etc.,) relative to a major axis of the boom upon which they are mounted. In some embodiments the angle of such nozzles is adjustable by a user (e.g. manually or via an actuator) in order to accommodate vessels of different shapes and dimensions. Such adjustments can be made in discrete increments (e.g. 1°, 2.5°, 5°, 7.5°, 10°, etc.) or the angle can be essentially infinitely adjustable (i.e. less than 1° increment).

Such a system can include a misting assembly at or near a terminus of the boom or elongated support (100) that can be positioned proximal to the work surface, which includes a misting nozzle (140) configured to dispense a diffuse droplet suspension (e.g. a spray, mist, aerosol, etc.) of a coating solution. Such a misting assembly can be in fluid communication (150 with a source of coating solution (such as a non-siliceous aqueous suspension) that includes one or more compounds that provide a low or reduced friction surface when contacted with the cleaned working surface. Examples of suitable coating solutions are described in U.S. Pat. No. 9,346,976 (to Davies), which is incorporated herein by reference.

Such a source of coating solution can be pressurized, for example by utilizing a reservoir containing compressed air and/or incorporation of one or more pumps within the fluid path. Such a misting assembly includes one or more nozzles that, in contrast with the nozzles of the spray assembly, are shaped to atomize or otherwise produce an aerosol or droplet mist of the coating solution. In a preferred embodiment of the inventive concept such a misting assembly can include at least two of such atomizing nozzles, with one directed to each end of the working surface and one directed to a central portion of the working surface. Such atomizing nozzles can be essentially spherical or configured as a portion of a sphere, and can eject mist, aerosol, and or fine spray over a wide radial or dispersive angle (e.g. 30°, 45°, 60°, 90°, 120°, 150°, 180°, 210°, 240°, 270°, 300°, 330°, 360°, or any intervening value). In some embodiments the radial or dispersive angle can be adjusted to accommodate dimensions and/or configuration of a vessel being cleaned. Such a configurable misting assembly can maintain a single radial or dispersive angle throughout a coating cycle, or the radial or dispersive angle can be adjusted during a coating cycle.

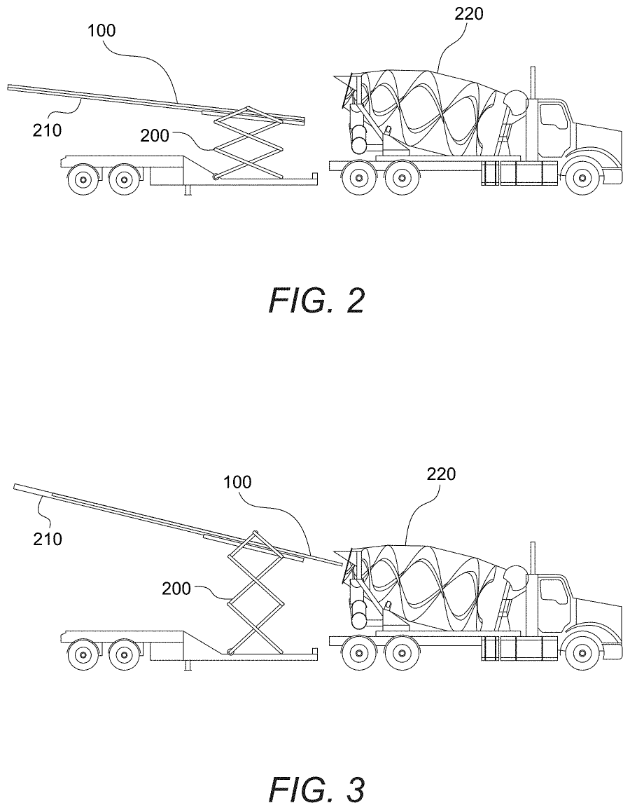

As shown in FIG. 2, systems of the inventive concept can support such an elongated support or boom (100) in or on the upper portion of a frame or similar supportive structure (200) in order to facilitate positioning of the elongated support and associated spray and misting assemblies relative to the working surface, in order to provide positioning of a nozzle and/or mist assembly proximal to said working surface. Such a frame can, for example, be articulated so as to elevate and/or tilt the elongated support (for example, a scissor lift).

Similarly, the elongated support or boom (100) can be coupled to an extendible support (210) that can be extended from one side of the frame (200) in order to provide horizontal positioning of the spray and misting assemblies. This facilitates proper orientation and positioning of the spray and misting assemblies proximal to working surfaces that are not readily accessible (for example, the interior wall of a rotating drum mixer, 220).

Systems of the inventive concept can include various accessory features that simplify use and improve safety. For example, a lower portion of the frame can include one or more wheels or rollers that aid in positioning. Such wheels or motors can be motorized. In some embodiments the system can include a controller, which is in electrical communication with various active components of the system (e.g. drive motors, pumps, switchable valves, sensors, etc.). Such a controller can be used to automate cleaning and coating of working surfaces by the system.

In use, such a system is first positioned and configured such that the end of the elongated support carrying the spray and misting assemblies is positioned proximal to the working surface to be cleaned and coated (for example, within a rotating drum mixer). For example, in embodiments directed to a rotating drum mixer for mixing concrete and other cementitious materials, an initial water stream (for example of pond water) is first dispensed through a spray assembly under sufficient pressure to dislodge the bulk of adhered cementitious materials. Suitable pressures can range from about 50 psi (344.7 kPa) to about 150 psi (1034.2 kPa), and are preferably about 100 psi (689.5 kPa). Dislodged cementitious materials, along with spent water, are subsequently removed from the work surface (for example, by rotation of the mixing drum, tilting, and/or other methods). A second water stream (for example of clean water) is then dispensed through a spray assembly in order to remove remaining traces of cementitious material from the work surface and the spent water (along with any suspended materials) removed. The misting assembly is then used to generate an atomized mist of a non-siliceous aqueous solution that is dispensed onto the cleaned working surface. The cleaned working surface can be used immediately, or utilized at a later time (e.g. the next morning). In a preferred embodiment this procedure is carried out at the end of a working day or duty cycle.

One should appreciate that systems and methods of the inventive concept reduce the amount of time and resources spent cleaning work surfaces used to prepare and dispense cementitious materials, and do so in an environmentally friendly and safe manner.

Examples of systems and methods of the inventive concept are provided in FIGS. 2 to 7, which depicts an exemplary sequence of events in which a system of the inventive concept is used to clean the interior surface of a rotating drum mixer of a concrete mixing truck by dislodging adherent residual concrete and application of a low friction coating. As shown in FIG. 2, a system of the inventive concept can include a supporting structure (e.g. a wheeled, articulated frame, 200) that can lift, tilt, and/or otherwise position an elongated support or boom (100) and orient it into a position for insertion of spray and misting nozzles into a vessel to be cleaned (in this example a rotating drum mixer, 220). Such an elongated support or boom (100) can be supported on an extendible support (210). As shown in FIG. 3, such an elongated support or boom (100) can be translated vertically and/or horizontally to move the spray and misting assemblies mounted thereon into alignment with an entry to the interior of the vessel and/or into the interior of the vessel. This can be accomplished, for example, by moving the extendible support (210) and/or by extension of the elongated support of boom (100) from the support structure.

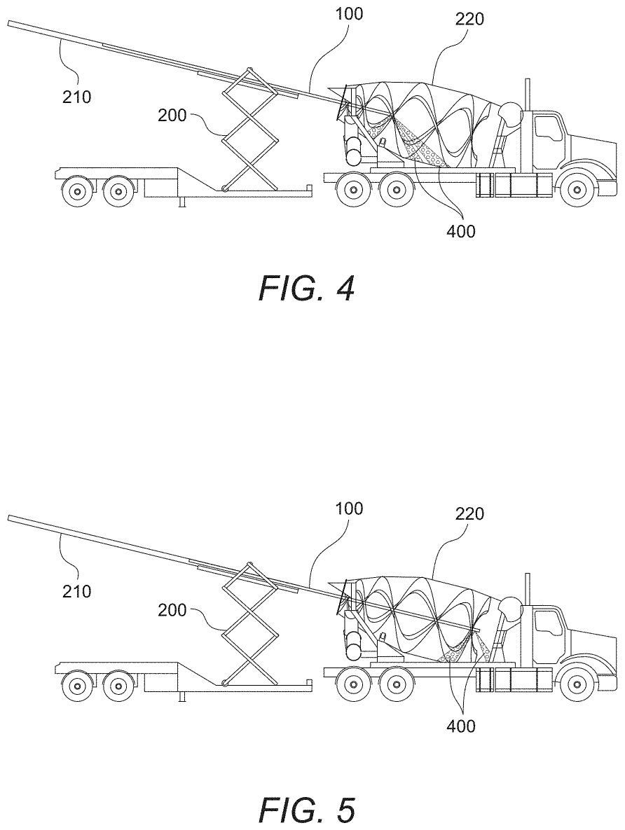

FIG. 4 shows insertion of the elongated support or boom (100) with its associated spray and misting assemblies into the vessel (220) and dispensing of a cleaning fluid stream or spray (400) through a spray nozzle onto the interior surface/wall of the vessel (220). In some embodiments the fluid is a gas (such as air); in other embodiments the fluid is a liquid (such as water or pond water). Such a fluid can be delivered under pressure sufficient to dislodge waste or residual materials clinging to the interior wall of the vessel, for example using a pressure of about 50 psi (344.7 kPa) to about 150 psi (1034.2 kPa).

As shown in FIG. 5, such an elongated support or boom (100) and an associated spray assembly with its fluid stream (400) can reposition during a cleaning (i.e. waste or residual material dislodging) step, for example by adjusting vertical and/or horizontal position of a supporting structure (200), and/or extension or retraction of the elongated support or boom (100) relative to the vessel being cleaned (220). In some embodiments the orientation of one or more spray or stream nozzles of such a spray assembly can be changed during cleaning, for example using an actuator coupled to such a spray or stream nozzle. Optionally, such a cleaning step can be repeated as necessary to remove sufficient residual or waste material from the interior wall of the vessel. In some embodiments a relatively impure source of fluid (such as pond water) can be used for an initial cleaning step, and second source of fluid (such as fresh water) can be used in a subsequent cleaning steps. These different cleaning fluids can be provided by the same spray nozzle (e.g. when provided with a switching valve) or by separate spray nozzles.

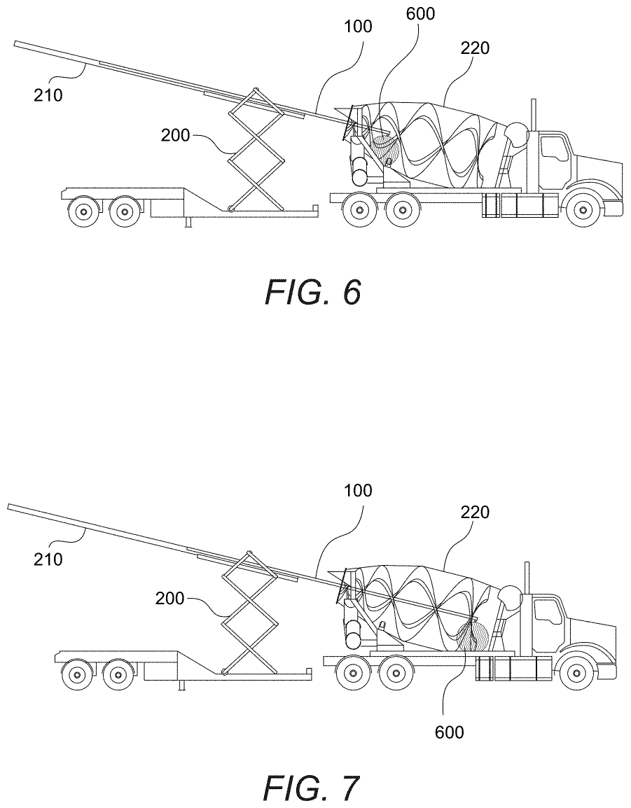

As shown in FIG. 6, following dislodging of residual or waste material from the interior wall of the vessel an aerosol or misting nozzle of a spray assembly associated with or coupled to an elongated support or boom (100) can be used to dispense of an aerosol, mist, fine spray, or other droplet suspension (600) of a non-siliceous aqueous coating solution onto the cleaned interior wall of the vessel (220). As shown in FIG. 7, the elongated support or boom (210) and the associated spray assembly (and, by association, a misting nozzle) can be moved within the interior of the vessel during this operation. In some embodiments dislodged waste or residual material can be removed prior to this coating step. In other embodiments dislodged waste or residual material can be removed following this coating step. Dislodged waste or residual material can be removed from the vessel by any suitable means, including tilting of the vessel to direct the dislodged material towards an aperture of the vessel, opening a hatch or similar aperture positioned at low point in the vessel, pumping, rotation of the vessel such that interior vanes directed movement of the dislodged material out of the vessel, or a combination of these.

In some embodiments a single spray assembly is provided, and is in fluid communication with one or more sources of cleaning fluid (e.g. water). Such sources can be pressurized, for example by utilizing a reservoir containing compressed air and/or incorporation of one or more pumps within the fluid path. If multiple sources of cleaning fluid are used a valve can be provided that permits switching between such water sources. For example, a source of pond water can be used for initial removal of waste or residual material, followed by clean water. In other embodiments two or more spray assemblies can be provided at the end of the elongated support, each connected to a different cleaning fluid source. In such an embodiment different spray assemblies can be implemented at different steps of the cleaning process in order to provide an optimally cleaned working surface.

In some embodiments of the inventive process the fluid can be a gas, such as a high velocity or pressurized (e.g. about 50 psi/344.7 kPa to about 150 psi/1034.2 kPa) stream of air. Such high velocity gas streams can be directed towards the inner walls of a vessel to be cleaned in order to dislodge and remove adhering materials. In such embodiments the system can include a nozzle suitable for directing such a gas stream as well as a source of compressed gas and/or a coupling suitable for connecting to an external source of compressed gas. Suitable sources of compressed gas include a pressurized gas tank and/or a compressor. In some embodiments both gas and liquid dispensing nozzles are provided, as well as sources for both gas and liquid.

Such fluid delivery nozzles can be positioned at or near a terminus of the boom that is inserted into the drum or vessel to be cleaned during use. In embodiments that include two or more nozzles, such nozzles can be positioned terminally and along the length of the boom.

In some embodiments systems of the inventive concept can be in fluid communication with a pressurized source of fluid. For example, such a system can include a fluid pumping mechanism that directs a flow of fluid (such as water, a cleaning solution, a coating solution, etc.) to an inlet portion of the boom. In such embodiments the system can include one or more fluid reservoirs that can be in fluid communication with the fluid pumping mechanism. Alternatively, such a fluid pumping mechanism can be coupled to an external source of fluid, such as a tank, reservoir, or pond, when in use. In some embodiments of the inventive concept the system does not include a fluid pumping mechanism, and can be coupled to a pressurized fluid source (such a pressurized line or an external pump) when in use.

Such a system can include one or more valves that can be actuated (manually or by an actuator) to control flow rate of the fluid through the boom. In some embodiments such a valve system can be used to select between different fluids to be supplied to the boom. Such a fluid pumping system can be in fluid communication with an external source of pressurized fluid as described above, or in alternative embodiments be coupled to a fluid pumping mechanism of the system. In some embodiments, actuated valves of the system can be actuated by a controller.

As noted above, systems of the inventive concept can include a controller. Such a controller can be in communication with motors, pumps, and/or actuators of the system, and serve to initiate, halt, and/or control the rate of such devices in order to control various functions of the system. For example, such a controller can be configured to operate lifting and other positioning functions of a supporting frame for a boom, extension and retraction of a boom, position of nozzles on a boom, and/or speed of pumps that deliver cleaning and/or coating fluids. A controller of the inventive concept can include a user interface to facilitate user interaction with the controller and access to functions of the system, as well as feedback about system performance.

In some embodiments the user interface is configured for manual operation of the system. In other embodiments the controller can include one or more programmed cleaning routines that can be selected and activated by a user. For example, in such an embodiment a user can ensure that the system is appropriately positioned relative to the drum mixer, tank, or other vessel to be cleaned and then select and/or activate a cleaning and coating program that is appropriate for the specific drum mixer, tank, or other vessel, whereupon the controller activates appropriate motor, actuators, and pumps at appropriate times and for appropriate intervals to effectively clean and/or coat the drum mixer, tank, or other vessel. In some embodiments one or more sensors can provide data to the controller that is in turn used to alter or modify a stored program, For example, if data from a sensor (e.g. a camera, turbidity sensor, conductivity sensor, etc.) indicates that significant contamination is still present at the end of a conventional cleaning cycle a stored algorithm can direct the controller to modify the current program to extend or repeat relevant cleaning steps. A user interface of the controller can include one or more fields that provide for selection of stored programs and/or to provide alerts to a user.

In some embodiments of the inventive concept the controller is collocated with the system. In other embodiments the controller or components of the controller are located in a separate physical location from that of the system, in which case communication with the system can be provided by any suitable means. Such means include wired communication and wireless communication (e.g. Wi-Fi, Bluetooth, cellular data, etc.). For example, some or all controller functions can be performed on a server that is in wireless communication with the system via an information or data network,

In some embodiments of the inventive concept the user interface can be collocated with the controller. In other embodiments the user interface can be provided on a physically separate device. In such embodiments the user interface can be supported by a handset, tablet, or similar device that is in communication with the controller. Such communication includes wired communication and wireless communication (e.g. Wi-Fi, Bluetooth, cellular data, etc.). For example, a user interface can be provided as an application on a smart phone, tablet, or similar device that is in wireless communication with a controller of the inventive concept via an information or data network,

While the above description provides examples directed to cementitious materials and removal thereof from mixing vessels, it should be appreciated that devices, systems, and methods of the inventive concept can be used to improve speed and/or efficiency of a variety of adherent materials from a variety of working surfaces. For example, devices, systems, and/or methods of the inventive concept can be applied to adherent road surfacing materials and working surfaces (e.g., mixing and/or dispensing equipment) that are exposed to them. Similarly, devices, systems, and/or methods of the inventive concept can be applied to soils, muds, slurries, mine wastes, and similar natural or partially natural materials and the working surfaces that are used in their transport and/or processing, or otherwise come into contact with them. In some embodiments, devices, systems, and methods of the inventive concept can be applied to food products (e.g., flours or other milled or powdered food products, doughs, pastes, slurries, suspensions, etc.) and working surfaces that are utilized in their processing, storage, and/or dispensing. In still other embodiments, devices, systems, and methods of the inventive concept can be applied to pharmaceuticals and/or cosmetic formulations (e.g., powders, granules, pastes, suspensions, emulsions, solutions, etc.) and working surfaces that are utilized in their processing, storage, and/or dispensing.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A system for cleaning materials from a working surface, comprising:
an elongated support;
a first spray assembly coupled to a terminus of the elongated support, wherein the first spray assembly comprises a first outlet configured to produce a stream of dispensed cleaning liquid; and
a mist assembly coupled to the terminus, wherein the mist assembly comprises a second outlet configured to atomize a coating liquid,
wherein the first spray assembly is in fluid communication with a first aqueous wash fluid and the mist assembly is in fluid communication with an aqueous surface treatment solution.

2. The system of claim 1, wherein the first aqueous wash fluid comprises pond water.

3. The system of claim 1, wherein the aqueous surface treatment solution is selected to generate a persistent low friction coating on contact with the working surface.

4. The system of claim 1, wherein the first spray assembly is in fluid communication with a second aqueous wash fluid, further comprising a valve that is in fluid communication with the first and second aqueous wash fluids and the first spray outlet.

5. The system of claim 1, further comprising a second spray assembly in fluid communication with a second aqueous wash fluid.

6. The system of claim 4 or claim 5, wherein the second aqueous wash fluid comprises fresh water.

7. The system of claim 1, further comprising an articulated assembly supporting the elongate support, wherein the articulated assembly is configured to extend vertically.

8. The system of claim 1, further comprising an extendable support coupled to the elongated support, such that extension of the extendable support displaces the first spray assembly horizontally.

9. The system of claim 1, wherein the first aqueous wash fluid is pressurized to from about 50 psi (344.7 kPa) to about 150 psi (1034.2 kPa).

10. The system of claim 1, further comprising a controller configured to: (i) dispense a stream of pond water onto the working surface, (ii) following dispensing of the stream of pond water, dispensing a stream of fresh water onto the working surface, and (iii) following dispensing of the stream of fresh water, dispensing a mist of the aqueous surface treatment solution onto the working surface through the mist assembly.

11. The system of claim 1, wherein the working surface is an interior surface of a rotating drum mixer.

12. The system of claim 1, wherein the first spray assembly comprises a laminar flow device.

13. A method of cleaning and coating a working surface, comprising:
using a system of claim 1, dispensing a first cleaning fluid through a first spray assembly onto a contaminated working surface to generate a first waste fluid and a partially cleaned working surface;
removing the first waste fluid from the partially cleaned working surface;
using a system of one of claims 1 to 11, dispensing a second cleaning fluid through a second spray assembly onto the partially cleaned working surface to produce a second waste fluid and a cleaned work surface;
removing the second waste fluid from the cleaned work surface; and
dispensing a non-siliceous aqueous coating solution onto the cleaned work surface using a misting assembly.

14. The method of claim 13, wherein the first spray assembly and the second spray assembly are the same spray assembly.

15. The method of claim 13, wherein the first spray assembly and the contaminated working surface move relative to each other as the first water spray is dispensed.

16. The method of claim 13, wherein the second spray assembly and the partially cleaned working surface move relative to each other as the second water spray is dispensed.

17. The method of claim 13, wherein the misting assembly and the cleaned working surface move relative to each other as the non-siliceous coating solution is dispensed.

18. The method of claim 13, wherein the first spray assembly, second spray assembly, and misting assembly are displaced vertically and horizontally using an elongated support and an articulated frame to bring them into proximity of the working surface prior to dispensing.

19. The method of claim 18, wherein data from a sensor is utilized to position the first spray assembly, second spray assembly, and misting assembly using a controller.

20. The method of claim 13, comprising passing the first cleaning fluid through a laminar flow device.

21. The method of claim 13, comprising passing the second cleaning fluid through a laminar flow device.
